(19) United States
(12) Patent Application Publication
(10) Pub. No.: US 2013/0048922 A1
(43) Pub. Date: Feb. 28, 2013

(54) METHOD FOR PREPARING QUANTUM DOTS OF LEAD SELENIDE

(71) Applicants: Mingjie Zhou, Guangdong (CN); Chun Wang, Guangdong (CN)

(72) Inventors: Mingjie Zhou, Guangdong (CN); Chun Wang, Guangdong (CN)

(73) Assignee: OCEAN'S KING LIGHTING SCIENCE & TECHNOLOGY CO., LTD., Guangdong (CN)

(21) Appl. No.: 13/696,378

(22) PCT Filed: May 11, 2010
(86) PCT No.: PCT/CN2010/072594

§ 371 Date: Nov. 6, 2012

(51) Int. Cl. H01B 1/06; B82Y 40/00; B82Y 30/00

(52) U.S. Cl. 252/519.3; 977/774; 977/896

(57) ABSTRACT

Provided is a method for preparing quantum dots of lead selenide, comprising the following steps: 1) mixing selenium powder with octadecene, heating with stirring to dissolve the selenium powder fully, maintaining the temperature, then cooling to room temperature to obtain a stock solution of selenium; 2) mixing lead compound, oleic acid, octadecene and benzophenone together, and dissolving to obtain a stock solution of lead, then maintaining the temperature at 130-190° C.; 3) adding the stock solution of selenium into the stock solution of lead rapidly, and maintaining the temperature at 100-160° C., after cooling, quantum dots of lead selenide are initially prepared; 4) adding the initially prepared quantum dots of lead selenide into a mixture of toluene and methanol, centrifugating and removing the supernatant to obtain a precipitate, then redissolving the precipitate with toluene to obtain a transparent solution of quantum dots of pure lead selenide. The method is safe in operation, simple, good in reproducibility and low in cost.

### FIELD OF THE INVENTION

The present invention relates to the technical field of preparation of nano-materials, particularly to a method for preparing lead selenide quantum dots.

### BACKGROUND OF THE INVENTION

Quantum dots refer to ultra fine particles having a particle size of 1-10 nm, and are “artificial molecules” comprising 103-105 atoms bound together. Theoretical analysis indicates that when the size of a semiconductor material gradually decreases from its bulk phase to a certain critical size, the characteristic dimension of the material in three dimensions becomes comparable to or less than the de Broglie wavelength or the mean free path of the electron, thereby three-dimensionally restricting the movement of electrons in the material. In other words, the energy of electrons are quantized in three dimensions. The materials in which electrons are restricted three-dimensionally are referred to as quantum dots. The radius of quantum dots is less than or close to the Bohr radius of excitons. Therefore, the quantum dots have unique quantum size effect and surface effect and have a broad application prospects in the light emitting materials, light sensors, etc. Lead selenide (PbSe) quantum dots, as an important semiconductor quantum dot material, can be applied in optoelectronics, biophysics and fluorescence microscopy. Due to its narrow bandgap, lead selenide can be used for producing light detectors, light resistors, light emitters, injection lasers and the like. Lead selenide can also be used as a diode laser source in the mid-infrared and far infrared regions of the spectrum. Furthermore, lead selenide can be widely used in detection of atmospheric pollutions, non-invasive medical diagnostics and automatic detection of exhaust gases and waste water, etc.

Organometallic method is one of the typical methods commonly used for preparing lead selenide quantum dots. Generally, lead selenide quantum dots are prepared at high temperature in the absence of water and oxygen using organo-lead compounds, selenium powder and the like as the raw materials, and using trioctyl phosphine oxide (TOPO), trioctylphosphine (TOP), tetrabutyl phosphate (TBP) and the like as the solvent/surfactant. Although high quality lead selenide quantum dots with good monodispersity may be obtained through such a synthetic method, the organic solvents used in the method such as TOPO, TOP, TBP are flammable, explosive, expensive and relatively toxic, which leads to high overall cost and is thus unfavorable for large scale production.

### DISCLOSURE OF THE INVENTION

### Technical Problems of the Invention

The technical problem to be solved by the present invention is to provide a method for preparing lead selenide quantum dots, which has the advantages of simple operations, mild experimental conditions and low-cost raw materials, to overcome the problems of the traditional method for preparing lead selenide quantum dots, such as high overall cost and severe experimental conditions.

### Technical Solution of the Invention

The technical solution to solve the technical problem of the present invention is to provide a method for preparing lead selenide quantum dots, which comprises the following steps:

Step 1: mixing selenium powder with octadecene, heating with stirring to dissolve the selenium powder completely, maintaining the temperature, then cooling to room temperature to obtain a stock solution of selenium;

Step 2: mixing a lead compound, oleic acid, octadecene and benzophenone, dissolving to obtain a stock solution of lead, and then maintaining the temperature at 130-190° C.;

Step 3: adding the stock solution of selenium of Step 1 into the stock solution of lead of Step 2 rapidly, and maintaining the reaction temperature at 100-160° C., after cooling, quantum dots of lead selenide are initially prepared;

Step 4: adding the initially prepared lead selenide quantum dots into a mixed solution of toluene and methanol, centrifuging the obtained mixture, removing the supernatant to obtain a precipitate, and re-dissolving the precipitate in toluene to obtain a transparent solution of pure lead selenide quantum dots.

In Step 1, the temperature may be maintained for 5-10 minutes. In Step 2, the lead compound, oleic acid, octadecene and benzophenone may be heated with stirring and dissolved under inert gas protection; the inert gas may be argon, and the stirring may be magnetic stirring. In Step 2, the lead compound may be lead oxide or lead acetate. In Step 3, the reaction time may be 300 seconds. In Step 4, the volume ratio of toluene to methanol may be 1:3. In Step 4, the process of centrifuging the mixture and removing the supernatant may be repeated for at least three times.

### The Beneficial Effects of the Invention

In the present invention, lead selenide quantum dots with different particle sizes and appearances are prepared with the method using simple lead compound and selenium powder as the raw materials by simply controlling the reaction conditions. The method of the present invention avoids the use of flammable, explosive, expensive and highly toxic compounds such as trioctylphosphine (TOP) or tributyl phosphine (TBP). Furthermore, the method of the present invention has the advantages of operation safety, simplicity, good reproducibility, and no need to use a glove box. The obtained lead selenide quantum dots have uniform distribution and very good monodispersity (size distribution of the lead selenide quantum dots is less than 10%).

### BRIEF DESCRIPTION OF THE FIGURES

The present invention will be further described referring to the Figures and Examples, in which:

FIG. 1 is a flowchart of the method for preparing the lead selenide quantum dots of the present invention;

FIG. 2 is an image of transmission electron microscopy of the lead selenide quantum dots prepared under the followings conditions: the reaction temperature is 100° C., the molar ratio of the Pb precursor to Se precursor is 3:1, and the reaction time is 5 minutes.

FIG. 3 is an image of transmission electron microscopy of the lead selenide quantum dots prepared under the followings conditions: the reaction temperature is 130° C., the molar ratio of the Pb precursor to Se precursor is 2:1, and the reaction time is 5 minutes.

FIG. 4 is an image of transmission electron microscopy of the lead selenide quantum dots prepared under the followings conditions: the reaction temperature is 160° C., the molar ratio of the Pb precursor to Se precursor is 1:1, and the reaction time is 5 minutes.

### PREFERRED EMBODIMENTS OF THE PRESENT INVENTION

In order to make the objects, technical solutions and advantages of the invention more apparent, the present invention will be further described referring to the Figures and the Examples. It should be understood that the embodiments described herein are merely illustration of the invention and shall not be construed to limit the invention.

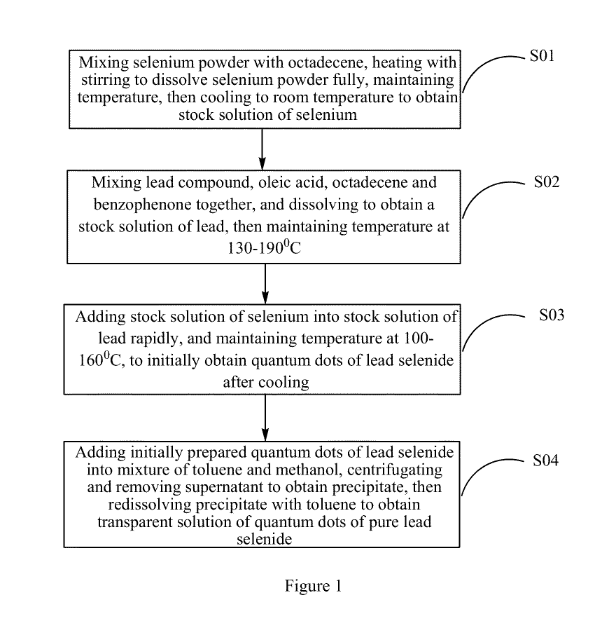

Referring to FIG. 1, which shows a flowchart of the method for preparing the lead selenide quantum dots of the Examples of the present invention, the method comprises the following steps:

S01: mixing selenium powder with octadecene, heating with stirring to dissolve the selenium powder completely, maintaining the temperature, then cooling to room temperature to obtain a stock solution of selenium

S02: mixing a lead compound, oleic acid, octadecene and benzophenone, dissolving to obtain a stock solution of lead, and then maintaining the temperature at 130-190° C.;

S03: adding the stock solution of selenium of S01 into the stock solution of lead of S02 rapidly, and maintaining the reaction temperature at about 100-160° C., after cooling, lead selenide quantum dots are initially prepared;

S04: adding the initially prepared lead selenide quantum dots into a mixed solution of toluene and methanol, centrifuging the obtained mixture, removing the supernatant to obtain a precipitate, re-dissolving the precipitate in toluene to obtain a transparent solution of pure lead selenide quantum dots.

In the preparation method of the present invention, the temperature may be maintained for 5-10 minutes in S01. In S02, the lead compound, oleic acid, octadecene and benzophenone may be heated with stirring and dissolved under inert gas protection; the inert gas may be argon, and the stirring may be magnetic stirring. In S02, the lead compound may be lead oxide or lead acetate. In S03, the reaction time may be 300 seconds. In S04, the volume ratio of toluene to methanol may be 1:3. In S04, the process of centrifuging the mixture and removing the supernatant may be repeated for at least three times.

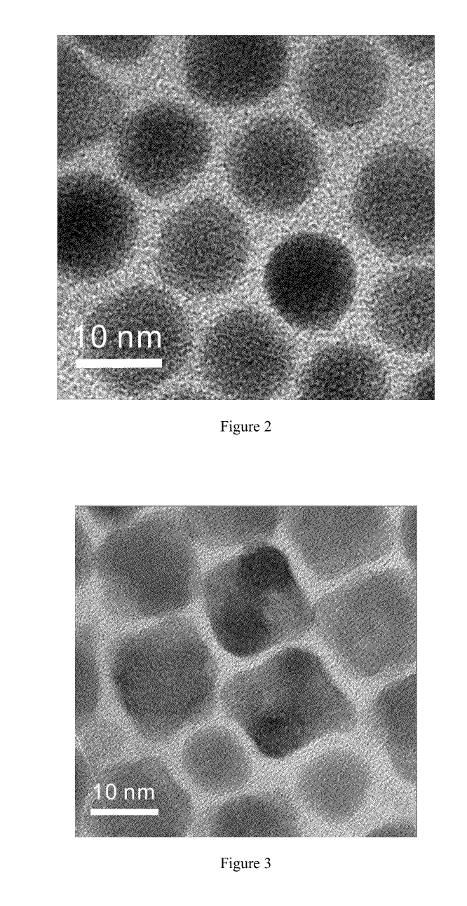

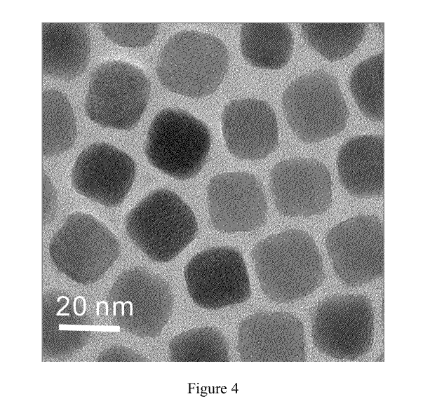

In the present invention, lead selenide quantum dots with different particle sizes and appearances are prepared with the method using simple lead compound (such as lead oxide, lead acetate, etc.) and selenium powder as the raw material by simply controlling the reaction conditions. The method of the present invention avoids the use of flammable, explosive, expensive and highly toxic compounds such as trioctylphosphine (TOP) or tributyl phosphine (TBP). Furthermore, the method of the present invention has the advantages of operation safety, simplicity, good reproducibility, and no need to use a glove box. The obtained lead selenide quantum dots have uniform distribution and very good monodispersity (size distribution of the quantum dots of lead selenide is less than 10%). As illustrated in FIGS. 2 to 4, FIG. 2 is an image of transmission electron microscopy of the lead selenide quantum dots prepared under the followings conditions: the reaction temperature is 100° C., the molar ratio of the Pb precursor to Se precursor is 3:1, and the reaction time is 5 minutes; FIG. 3 is an image of transmission electron microscopy of the lead selenide quantum dots prepared under the followings conditions: the reaction temperature is 130° C., the molar ratio of the Pb precursor to Se precursor is 2:1, and the reaction time is 5 minutes; FIG. 4 is an image of transmission electron microscopy of the lead selenide quantum dots prepared under the followings conditions: the reaction temperature is 160° C., the molar ratio of the Pb precursor to Se precursor is 1:1, and the reaction time is 5 minutes.

The lead selenide quantum dots synthesized through the preparation method above can be used in solar cells, light emitting diodes and light emitting devices, etc.

The lead selenide quantum dots prepared with different molar ratios of the precursors, different reaction temperatures, and different lead precursors are exemplified in the following Examples.

### Example 1

Step 1: 3 mMol (millimole) of selenium powder and 5 ml of octadecene (ODE) are added into a 25 ml three-necked flask, which is then heated to 200° C.-220° C. with homogenous stirring to dissolve the selenium powder completely. The temperature is maintained for 5-10 minutes, followed by cooling to room temperature to give a stock solution of selenium.

Step 2: 1 mMol (millimole) of lead oxide (PbO), 5 mMol of oleic acid (OA), 10 mL of octadecene (ODE) and 5 mMol of benzophenone are added into a 25 mL three-necked flask, which is then heated to 130° C. under argon protection with vigorous magnetic stirring until the materials are sufficiently dissolved to form a stock solution of lead. The temperature is maintained at 130° C.

Step 3: the stock solution of selenium is drawn with a syringe in an amount such that the molar ratio of Pb to Se in the solution is 3:1, and is added rapidly into the stock solution of lead at 130° C. After the addition, the temperature would normally decrease by 30° C. The reaction temperature is maintained at about 100° C. for a reaction time of 300 seconds, after which the electrical source of the heater is shut down. After cooling, the lead selenide quantum dots are obtained.

Step 4: the obtained lead selenide quantum dots are added into a mixed solution of toluene and methanol (the volume ratio of toluene to methanol is 1:3). The obtained mixture is centrifuged and the supernatant is removed. Then the residue is added into a mixed solution of toluene and methanol (the volume ratio of toluene to methanol is 1:3) again. The process of centrifuging the mixture and removing the supernatant is repeated for two more times, and a precipitate is finally obtained. The precipitate is then dissolved in toluene to obtain a transparent solution of pure lead selenide quantum dots.

### Example 2

Step 1: 2 mMol of selenium powder and 5 ml of octadecene (ODE) are added into a 25 ml three-necked flask, which is then heated to 200° C.-220° C. with homogenous stirring to dissolve the selenium powder completely. The temperature is maintained for 5-10 minutes, followed by cooling to room temperature to give a stock solution of selenium.

Step 2: 1 mMol of lead oxide (PbO), 5 mMol of oleic acid (OA), 10 mL of octadecene (ODE) and 5 mMol of benzophenone are added into a 25 mL three-necked flask, which is then heated to 160° C. under argon protection with vigorous magnetic stirring until the materials are sufficiently dissolved to form a stock solution of lead. The temperature is maintained at 160° C.

Step 3: the stock solution of selenium is drawn with a syringe in an amount such that the molar ratio of Pb to Se in the solution is 2:1, and is added rapidly into the stock solution of lead at 160° C. After the addition, the temperature would normally decrease by 30° C. The reaction temperature is maintained at about 130° C. for a reaction time of 300 seconds, after which the electrical source is shut down. After cooling, the lead selenide quantum dots are obtained.

Step 4: the obtained lead selenide quantum dots are added into a mixed solution of toluene and methanol (the volume ratio of toluene to methanol is 1:3). The obtained mixture is centrifuged and the supernatant is removed. Then the residue is added into a mixed solution of toluene and methanol (the volume ratio of toluene to methanol is 1:3) again. The process of centrifuging the mixture and removing the supernatant is repeated for two more times, and a precipitate is finally obtained. The precipitate is then dissolved in toluene to obtain a transparent solution of pure lead selenide quantum dots.

### Example 3

Step 1: 1 mMol of selenium powder and 5 ml of octadecene (ODE) are added into a 25 ml three-necked flask, which is then heated to 200° C.-220° C. with homogenous stirring to dissolve the selenium powder completely. The temperature is maintained for 5-10 minutes, followed by cooling to room temperature to give a stock solution of selenium.

Step 2: 1 mMol of lead oxide (PbO), 5 mMol of oleic acid (OA), 10 mL of octadecene (ODE) and 5 mMol of benzophenone are added into a 25 mL three-necked flask, which is then heated to 190° C. under argon protection with vigorous magnetic stirring until the materials are sufficiently dissolved to form a stock solution of lead. The temperature is maintained at 190° C.

Step 3: the stock solution of selenium is drawn with a syringe in an amount such that the molar ratio of Pb to Se in the solution is 1:1, and is added rapidly into the stock solution of lead at 190° C. After the addition, the temperature would normally decrease by 30° C. The reaction temperature is maintained at about 160° C., for a reaction time of 300 seconds, after which the electrical source is shut down. After cooling, the lead selenide quantum dots are obtained.

Step 4: the obtained lead selenide quantum dots are added into a mixed solution of toluene and methanol (the volume ratio of toluene to methanol is 1:3). The obtained mixture is centrifuged and the supernatant is removed. Then the residue is added into a mixed solution of toluene and methanol (the volume ratio of toluene to methanol is 1:3) again. The process of centrifuging the mixture and removing the supernatant is repeated for two more times, and a precipitate is finally obtained. The precipitate is then dissolved in toluene to obtain a transparent solution of pure lead selenide quantum dots.

### Example 4

Step 1: 3 mMol of selenium powder and 5 ml of octadecene (ODE) are added into a 25 ml three-necked flask, which is then heated to 200° C.-220° C. with homogenous stirring to dissolve the selenium powder completely. The temperature is maintained for 5-10 minutes, followed by cooling to room temperature to give a stock solution of selenium.

Step 2: 1 mMol of lead acetate, 3 mMol of oleic acid (OA) and 5 mL of octadecene (ODE) are added into a 25 mL three-necked flask, which is then heated to 130° C. under argon protection with vigorous magnetic stirring until the materials are sufficiently dissolved to form a stock solution of lead. The temperature is maintained at 130° C.

Step 3: the stock solution of selenium is drawn with a syringe in an amount such that the molar ratio of Pb to Se in the solution is 3:1, and is added rapidly into the stock solution of lead at 130° C. After the addition, the temperature would normally decrease by 30° C. The reaction temperature is maintained at about 100° C. for a reaction time of 300 seconds, after which the electrical source is shut down. After cooling, the lead selenide quantum dots are obtained.

Step 4: the obtained lead selenide quantum dots are added into a mixed solution of toluene and methanol (the volume ratio of toluene to methanol is 1:3).The obtained mixture is centrifuged and the supernatant is removed. Then the residue is added into a mixed solution of toluene and methanol (the volume ratio of toluene to methanol is 1:3) again. The process of centrifuging the mixture and removing the supernatant is repeated for two more times, and a precipitate is finally obtained. The precipitate is then dissolved in toluene to obtain a transparent solution of pure lead selenide quantum dots.

### Example 5

Step 1: 2 mMol of selenium powder and 5 ml of octadecene (ODE) are added into a 25 ml three-necked flask, which is then heated to 200° C.-220° C. with homogenous stirring to dissolve the selenium powder completely. The temperature is maintained for 5-10 minutes, followed by cooling to room temperature to give a stock solution of selenium.

Step 2: 1 mMol of lead acetate, 3 mMol of oleic acid (OA) and 5 mL of octadecene (ODE) are added into a 25 mL three-necked flask, which is then heated to 160° C. under argon protection with vigorous magnetic stirring until the materials are sufficiently dissolved to form a stock solution of lead. The temperature is maintained at 160° C.

Step 3: the stock solution of selenium is drawn with a syringe in an amount such that the molar ratio of Pb to Se in the solution is 2:1, and is added rapidly into the stock solution of lead at 160° C. After the addition, the temperature would normally decrease by 30° C. The reaction temperature is maintained at about 130° C. for a reaction time of 300 seconds, after which the electrical source is shut down. After cooling, the lead selenide quantum dots are obtained.

Step 4: the obtained lead selenide quantum dots are added into a mixed solution of toluene and methanol (the volume ratio of toluene to methanol is 1:3). The obtained mixture is centrifuged and the supernatant is removed. Then the residue is added into a mixed solution of toluene and methanol (the volume ratio of toluene to methanol is 1:3) again. The process of centrifuging the mixture and removing the supernatant is repeated for two more times, and a precipitate is finally obtained. The precipitate is then dissolved in toluene to obtain a transparent solution of pure lead selenide quantum dots.

### Example 6

Step 1: 1 mMol of selenium powder and 5 ml of octadecene (ODE) are added into a 25 ml three-necked flask, which is then heated to 200° C.-220° C. with homogenous stirring to dissolve the selenium powder completely. The temperature is maintained for 5-10 minutes, followed by cooling to room temperature to give a stock solution of selenium.

Step 2: 1 mMol of lead acetate, 3 mMol of oleic acid (OA) and 5 mL of octadecene (ODE) are added into a 25 mL three-necked flask, which is then heated to 190° C. under argon protection with vigorous magnetic stirring until the materials are sufficiently dissolved to form a stock solution of lead. The temperature is maintained at 190° C.

Step 3: the stock solution of selenium is drawn with a syringe in an amount such that the molar ratio of Pb to Se in the solution is 1:1, and is added rapidly into the stock solution of lead at 190° C. After the addition, the temperature would normally decrease by 30° C. The reaction temperature is maintained at about 160° C. for a reaction time of 300 seconds, after which the electrical source is shut down. After cooling, the lead selenide quantum dots are obtained.

Step 4: the obtained lead selenide quantum dots are added into a mixed solution of toluene and methanol (the volume ratio of toluene to methanol is 1:3). The obtained mixture is centrifuged and the supernatant is removed. Then the residue is added into a mixed solution of toluene and methanol (the volume ratio of toluene to methanol is 1:3) again. The process of centrifuging the mixture and removing the supernatant is repeated for two more times, and a precipitate is finally obtained. The precipitate is then dissolved in toluene to obtain a transparent solution of pure lead selenide quantum dots.

Described above are merely preferred embodiments of the present invention, and are not intended to limit the present invention. Any modification, equivalent replacement and improvement made without departing from the spirit and principle of the present invention shall be encompassed in the protection scope of the present invention.

1. A method for preparing lead selenide quantum dots, which comprises the following steps:
Step 1: mixing selenium powder with octadecene, heating with stirring to dissolve the selenium powder completely, maintaining the temperature, then cooling to room temperature to obtain a stock solution of selenium;
Step 2: mixing a lead compound, oleic acid, octadecene and benzophenone, dissolving to obtain a stock solution of lead, and then maintaining the temperature at 130-190° C.;
Step 3: adding the stock solution of selenium of Step 1 into the stock solution of lead of Step 2 rapidly, and maintaining the reaction temperature at 100-160° C., after cooling, lead selenide quantum dots are initially prepared;
Step 4: adding the initially prepared lead selenide quantum dots into a mixed solution of toluene and methanol, centrifuging the obtained mixture, removing the supernatant to obtain a precipitate, re-dissolving the precipitate in toluene to obtain a transparent solution of pure lead selenide quantum dots.

2. The method according to claim 1, wherein the temperature is maintained for 5-10 minutes in Step 1.

3. The method according to claim 1, wherein the lead compound, oleic acid, octadecene and benzophenone are heated with stirring and dissolved under inert gas protection in Step 2.

4. The method according to claim 3, wherein the inert gas is argon, and the stirring is magnetic stirring.

5. The method according to claim 1, wherein the lead compound is lead oxide or lead acetate in Step 2.

6. The method according to claim 1, wherein the reaction time is 300 seconds in Step 3.

7. The method according to claim 1, wherein the volume ratio of toluene to methanol is 1:3 in Step 4.

8. The method according to claim 1, wherein the process of centrifuging the mixture and removing the supernatant is repeated for at least three times in Step 4.

9. The method according to claim 3, wherein the lead compound is lead oxide or lead acetate in Step 2.
